(19) United States
(12) Patent Application Publication
(10) Pub. No.: US 2013/0318209 A1
(43) Pub. Date: Nov. 28, 2013

(54) DISTRIBUTED DECISION SERVICE

(71) Applicant: INTERNATIONAL BUSINESS MACHINES CORPORATION, (US)

(72) Inventor: PIERRE D. FEILLET, GENTILLY (FR)

(73) Assignee: INTERNATIONAL BUSINESS MACHINES CORPORATION, ARMONK, NY (US)

(21) Appl. No.: 13/859,830

(22) Filed: Apr. 10, 2013

(30) Foreign Application Priority Data
May 22, 2012 (GB) 1209011.4

(51) Int. Cl. G06F 15/16

(52) U.S. Cl. CPC H04L 67/32
USPC 709/219

(57) ABSTRACT

A method, system and/or computer program product creates a distributed decision service. A call is received from a client requesting a decision service. A thin data model of the data required for that decision service is built and sent to the requesting client. A thin data set, based on the thin data model, is received from the client. A decision is formed by performing a decision service on the thin data set, and the decision is sent to the client.

This application is based on and claims the benefit of priority from United Kingdom Patent Application 1209011.4, filed on May 22, 2012, and herein incorporated by reference in its entirety.

### BACKGROUND

This invention relates to a method and apparatus for a distributed decision service. In particular this invention pertains to the area of middleware and large enterprise software, including databases, software-as-a-service architectures, Web services, Web mashups and business process management. The embodiments address the need to optimize distributed decision services, such as distributed rule engines or distributed complex event processors, in particular, avoiding to transmit more data than necessary for the decision making process to complete.

Decision services, such as business rules engines, are built on complex data object models, representing the totality, or at least a very large portion of the information available to make decisions, in a variety of possible contexts. By contrast, a decision service implemented to suit a particular need may only rely on a very small portion of this data object model. In consequence, the transport layer interfacing decision clients with decision services is encumbered by needless data, resulting in unneeded bandwidth usage and degraded performance. In particular, it will frequently occur that the time to transmit the data and retrieve the result is longer than the actual time it took to make the decision.

Previous techniques minimize data transfer between two computers, including a host computer that provides an object stored in the host computer to a target computer. In response to a need for an object at the target computer, the host computer generates and transfers to the target computer a proxy program instead of the object. The proxy program, when executed at the target computer, provides the object. Usually, the proxy program is much shorter than the object itself, and this reduces message traffic. The proxy program has various forms such as a call to another program resident in the target computer to recreate the object or a request to a function within the target computer to provide the object. The host computer can also be programmed into an object oriented environment, the object referencing other objects, and the proxy program forming an agent in the target computer which requests these other objects from the host computer only as needed by the target computer.

Other previous processes utilize a data access system and method with proxy and remote processing including apparatus and methods of accessing and visualizing data stored at a remote host on a computer network. A proxy server receives a request for data from a client, and in response, makes a determination whether the data specified in the request should be rendered. If the proxy server determines that the requested data should be rendered, the proxy server then transmits a rendering determination to a processing server coupled to the proxy server. The proxy server then renders the requested data and transmits the rendered data to the client.

Other previous processes utilize a method for fast decision-making in highly distributed systems including a prediction system for initiating a data transfer to a decision system. The prediction system is configured to identify a decision, the decision being a result of a computation of the decision system according to a set of predefined rules and input data. The prediction system is further configured to identify predicted input data representing a portion of the input data and to initiate a transfer of the predicted input data to the decision system prior to the computation of the decision.

The above prior art have in common that large amounts of data are exchanged between a client and its service or services.

### SUMMARY

A method, system and/or computer program product creates a distributed decision service. A call is received from a client requesting a decision service. A thin data model of the data required for that decision service is built and sent to the requesting client. A thin data set, based on the thin data model, is received from the client. A decision is formed by performing a decision service on the thin data set, and the decision is sent to the client.

### BRIEF DESCRIPTION OF THE SEVERAL VIEWS OF THE DRAWINGS

Various embodiments of the present invention will now be described, by way of example only, with reference to the following drawings in which:

FIG. 1 is a deployment diagram of the system of one embodiment;

FIG. 2 is a component diagram of one embodiment;

FIG. 3 is a method diagram of one embodiment;

FIG. 4 is a schematic representation of a thin data model transformation;

FIG. 5 is an example state diagram of a data model and thin data model after a thin data model transformation;

FIG. 6 is example state diagram for subsequent data model 260 and dataset 262 continuing the example of FIG. 5;

FIG. 7 is an example state diagram for subsequent thin data set 214 and thin decision 216 continuing the example of FIG. 6; and

FIG. 8 is an example state diagram for subsequent decision 264 and complete data set 266 continuing the example of FIG. 7.

### DETAILED DESCRIPTION

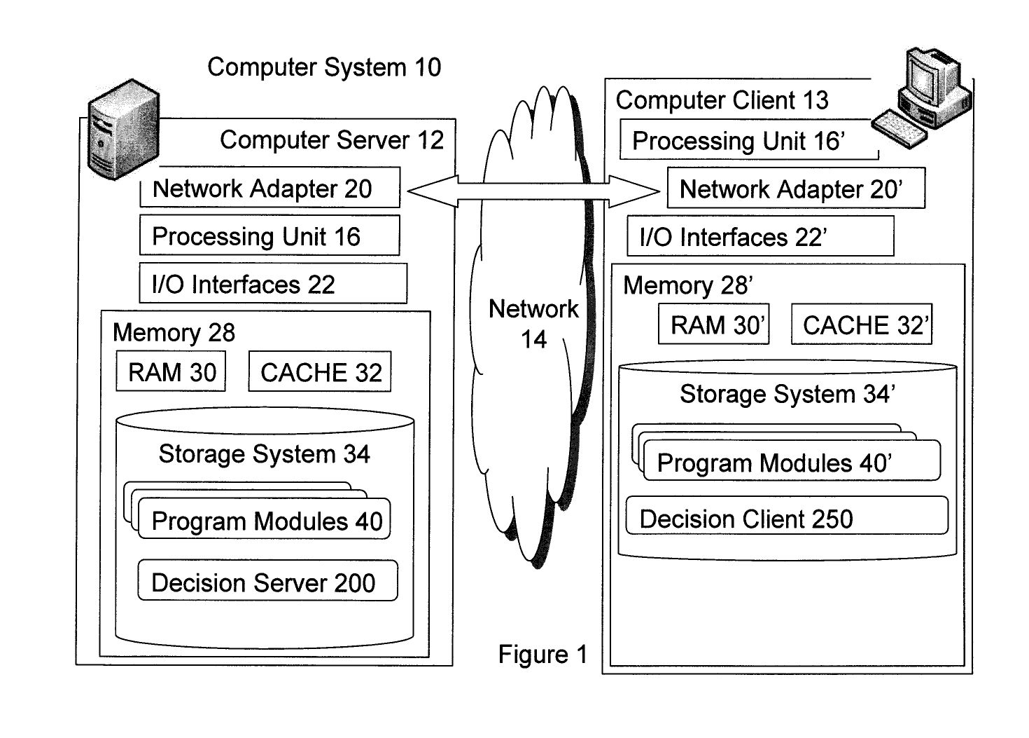

Referring to FIG. 1, there is shown a deployment diagram of an embodiment in computer system 10. Computer system 10 comprises: computer server 12; computer client 13 and network 14. Examples of well-known computing systems, environments, and/or configurations that may be suitable for use with computer server 12 and client 13 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer server 12 and client 13 may be described in the general context of computer system-executable instructions, such as program modules, being executed by a computer system. Generally, program modules may include routines, programs, objects, components, logic, data structures, and so on that perform particular tasks or implement particular abstract data types. Computer server 12 and client 13 may be embodied in distributed cloud computing environments where tasks are performed by remote processing devices that are linked through a communications network. In a distributed cloud computing environment, program modules may be located in both local and remote computer system storage media including memory storage devices. As shown in FIG. 1, computer server 12 and client 13 are general-purpose computing devices. The components of computer server 12 and client 13 may include, but are not limited to, one or more processors or processing units 16, 16′, a system memory 28, 28′, and respective buses (not shown) that couples various system components including system memory 28, 28′ to processor 16, 16′.

The buses can represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer server 12 and client 13 typically include a variety of computer system readable media. Such media may be any available media that is accessible by computer server 12 and client 13 and includes both volatile and non-volatile media, removable and non-removable media.

System memory 28, 28′ can include computer system readable media in the form of volatile memory, such as random access memory (RAM) 30, 30′; cache memory 32, 32′ and storage system 34, 34′. Computer server 12 and client 13 may further include other removable/non-removable, volatile/non-volatile computer system storage media. By way of example only, storage system 34, 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to respective buses by one or more data media interfaces. As will be further depicted and described below, memory 28, 28′ may include at least one program product having a set (for example, at least one) of program modules that are configured to carry out the functions of embodiments of the invention.

A set of program modules 40, 40′ may be stored in memory 28, 28′ by way of example, and not limitation, as well as an operating system, one or more application programs, other program modules, and program data. Each of the operating system, one or more application programs, other program modules, and program data or some combination thereof, may include an implementation of a networking environment. One server program module, decision server 200, is provided to carry out the functions and/or methodologies of embodiments of the invention as described herein. One client program module, decision client 250, is provided to carry out the functions and/or methodologies of embodiments of the invention as described herein.

Computer server 12 and client 13 may also communicate with one or more external devices such as a keyboard, a pointing device, a display, etc.; one or more devices that enable a user to interact with computer server 12 (possibly a developer or administrator) or client 13 (possibly an agent); and/or any devices (for example a network card or modem) that enable computer server 12 or client 13 to communicate with one or more other computing devices. Such communication can occur via I/O interfaces 22 and 22′ respectively. Still yet, computer server 12 and client 13 communicate with one another and other network devices over one or more networks such as a local area network (LAN), a general wide area network (WAN), and/or a public network (e.g., the Internet) via network adapters 20 and 20′ respectively. It should be understood that although not shown, other hardware and/or software components could be used in conjunction with computer server 12 and client 13. Examples include, but are not limited to: microcode, device drivers, redundant processing units, external disk drive arrays, RAID systems, tape drives, and data archival storage systems.

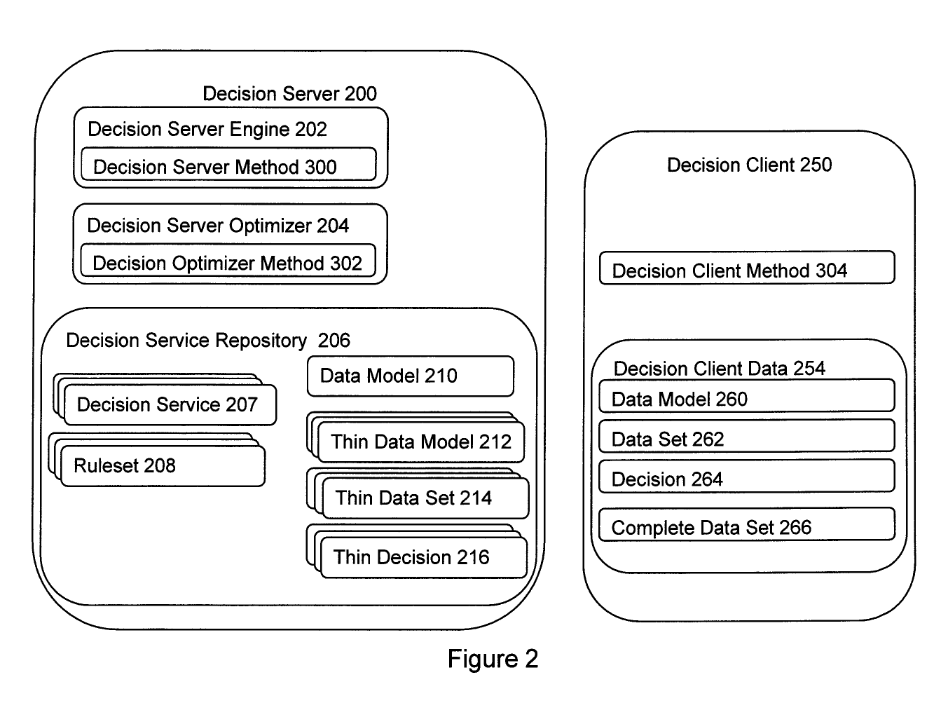

Referring to FIG. 2, the operating components of decision server 200 and decision client 250 are shown.

Decision server 200 comprises: decision server engine 202; decision server optimizer 204; and decision service repository 206.

Decision server engine 202 is for making a thin decision 216, on request from a client, using a ruleset 208 to operate on a data model 210. Thin decision 216 is returned to the decision client 250. Decision server engine 202 comprises decision server method 300. In one embodiment the decision server engine 202 operates on data model 210 to modify and extend the data including or appending decision data.

Decision server optimizer 204 is for optimizing the interactions of the client and server using decision optimizer method 302.

Decision service repository 206 is for storing: decision services including decision service 207; rulesets including ruleset 208; data models including data model 210; thin data models including thin data model 212; and decisions including thin decision 216.

Decision service 207 is one of many decision services stored in the decision service repository 206. A decision service is the component that defines at the highest level: what is service is about; what are its high level operations; and what is its associated ruleset. Ruleset 208 is associated with decision service 207.

Ruleset 208 is one of many rulesets for operating on one of many data models (for example data model 210) to return a thin data model (for example 212). Each ruleset has an associated data model, associated with ruleset 208 is data model 210.

Data model 210 is a collection of field names or data classes used to represent the structure of all data used to make all the decisions by the decision server. Therefore a data model can be considered to be a superset of the data fields for all services.

Thin data model 212 is one of many thin data models, each being a sub-set of field names (also known as data classes) from data model 210 corresponding to the field names or data classes used by an associated particular ruleset in association with a particular decision service. Thin data model 212 is generated from ruleset 208 and is therefore associated with decision service 207.

Thin data set 214 is a data set sent by decision client 250 corresponding to a particular thin data model 212 with completed data fields.

Thin decision 216 is the result of decision server engine 202 executing on thin data set 214 and ruleset 208. In one embodiment, thin decision 216 is a modified and extended thin data set 214.

Decision client 250 comprises: decision client method 304 and decision client data 254. In one embodiment, decision client 250 is a known decision client and is unaware of the optimizations of the server.

Decision client method 304 is for initiating and processing a decision process and is described below.

Decision client data 254 is for storing: a data model 260; a data set 262; and a decision 264. Note that the term “thin” is not used in the context of one embodiment decision client 250 because although the data set 262 may be the same thin data set 214 of the decision server 200, the decision client 250 is unaware if it is thin or not.

Data model 260 is for storing thin data model 212. It would also store the complete data model 210 in various embodiments.

Data set 262 is for storing the completed data fields corresponding to the data model 260. This data set 262 is sent to the decision server 200 and corresponds to thin data set 214 stored by the decision server because it is received after sending the thin data model 212.

Decision 264 is for storing thin decision 216 made by the decision server 200 when received by decision client 250. In one embodiment, decision 264 is thin data set 214 modified and/or extended to contain a decision.

Complete data set 266 is for storing the complete data set of which decision 264 is only a sub-set.

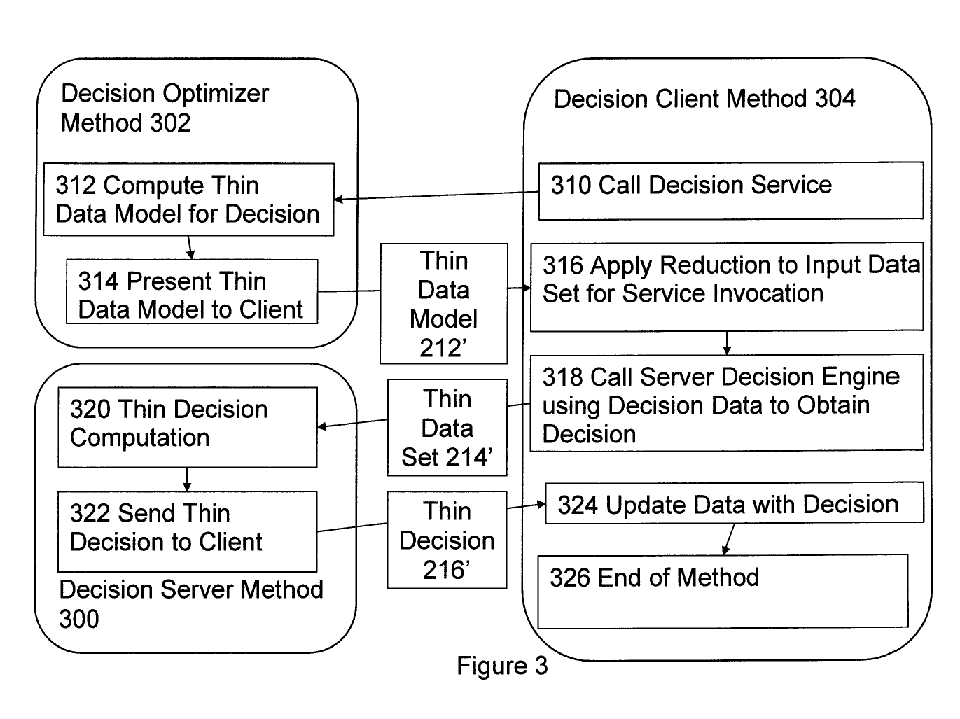

Referring to FIG. 3, decision server method 300, decision optimizer method 302 and decision client method 304 of one embodiment comprise logical process steps 310 to 326.

Step 310 of decision client method 304 is for calling the decision service on the server (i.e., decision server 200 depicted in FIG. 2). Typically an agent will select a decision service and that action will initiate the selected decision service.

Step 312 of decision optimizer method 302 is initiated after the decision service is selected and is for computing thin data model 212′ based on the associated decision service ruleset 208 and the data model 210. The computation of the thin data model 212′ is performed by a dedicated sub-method based on identifying the classes and members in the execution units of associated rule set 208. For instance, the dedicated sub-method could look like:

```
1 For all execution units
  2 For all tests in execution unit
    3 For all class member attributes
      4 Add class to thin data model
        5 Add member to thin data model
6 Returns the thin data model
```

Resulting thin data model 212′ may also be called a thin class model in systems where the data is referred to as data classes (just the field names) and data objects (the field names with corresponding data fields). It may also be called a thin data or class model.

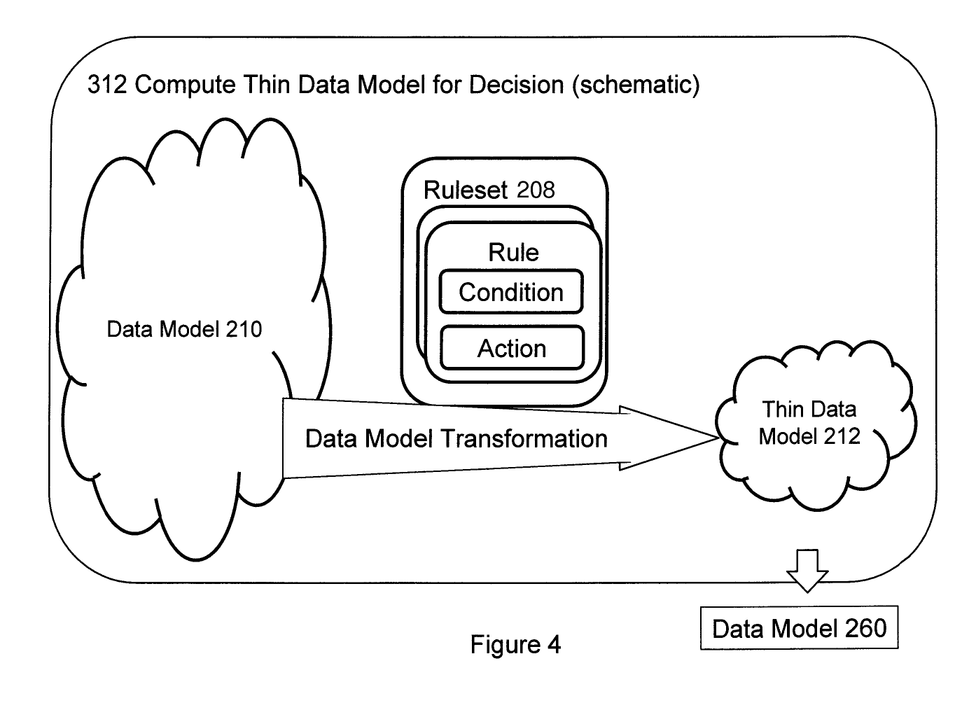

Referring to FIG. 4, there is shown a schematic representation of computing a thin data model using a ruleset. Note that data model 210 is depicted as being larger than thin data model 212, thus indicating that thin data model 212 uses less (or at least less significant) data than data model 210.

Referring back to FIG. 3, step 314 is for presenting thin data model 212′ from thin data model 212 storage in the server to the client.

Step 316 is for building a thin data set, in the decision client method 304, by applying data model reduction to the data set prior to the invocation.

Step 318 is for calling the server decision engine and requesting a decision service using thin data set 214′ from data set 262 storage in the decision client method 304. Thin data set 214′ is stored in thin data set 214 in the decision service repository 206.

Step 320 is for computing, by the decision server method 300, a thin decision 216′ using ruleset 208 on thin data set 214′.

Step 322 is for sending thin decision 216′ from thin decision 216 storage in the decision service repository to decision 264 in the decision client 250.

Step 324 is for updating the complete data set 266 with the decision data in decision 264.

Step 326 is the end of the method.

An example of the operation of the present embodiment is now described. A financial company puts in place a loan decision service. This service automates a loan validation policy, and to provide a loan validation application to its agents. The loan decision service: validates input data from a Web application; calculates customer eligibility (given their personal profile and the requested loan amount); evaluates specific criteria or score to accept or reject the loan; and computes an insurance rate, if the loan is accepted, from a function of the computed score.

The example of the service is specified with parameters: borrower id, age, yearly income, and assets. The loan amount, duration and interest rate could also be involved but have been left out of the example to simplify the explanation.

The financial company has a multipurpose data model to cope with all applications involving a borrower and a loan with a superset of fields required by each application. This model contains the birth date, the list of assets, medical information to participate into all processing. But only a subset of the data model is required by the loan decision service and consequently, unnecessary data can be cut at client invocation. Such a reduction results in a decreased data transport, lower bandwidth usage and a lower latency for a better customer experience.

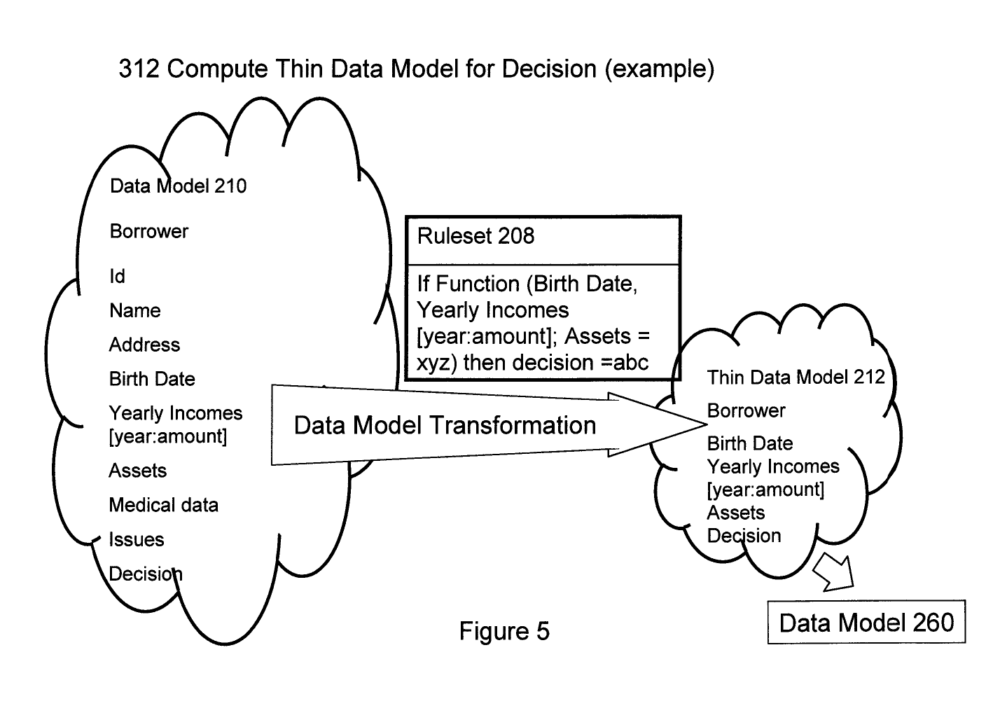

Referring to FIG. 5, there are shown example field names for FIG. 4's representation of step 312 computing a thin data model 212 from data model 210 using ruleset 208. Data model 210 comprises the following data classes: borrower id; name; address; birth date; yearly incomes [year; amount]; assets; medical data; issues and decision, Ruleset 208 comprises a condition and an action. The condition is: If Function (borrower; birth date; yearly incomes [year; amount]; assets)=xyz. The action is decision=abc. Step 312 creates thin data model 212 by keeping data classes in the data model if they are in the ruleset. Thin data model 212 can be seen to contain: borrower id; birth date; yearly incomes [year; amount], assets, and decision. Therefore, name, address, medical data and issues are cut from the thin data model and not carried when invoking the loan decision service. Borrower id is kept in the thin data model by default. The thin data model is sent from thin data model 212 in the server to data model 260 in the client.

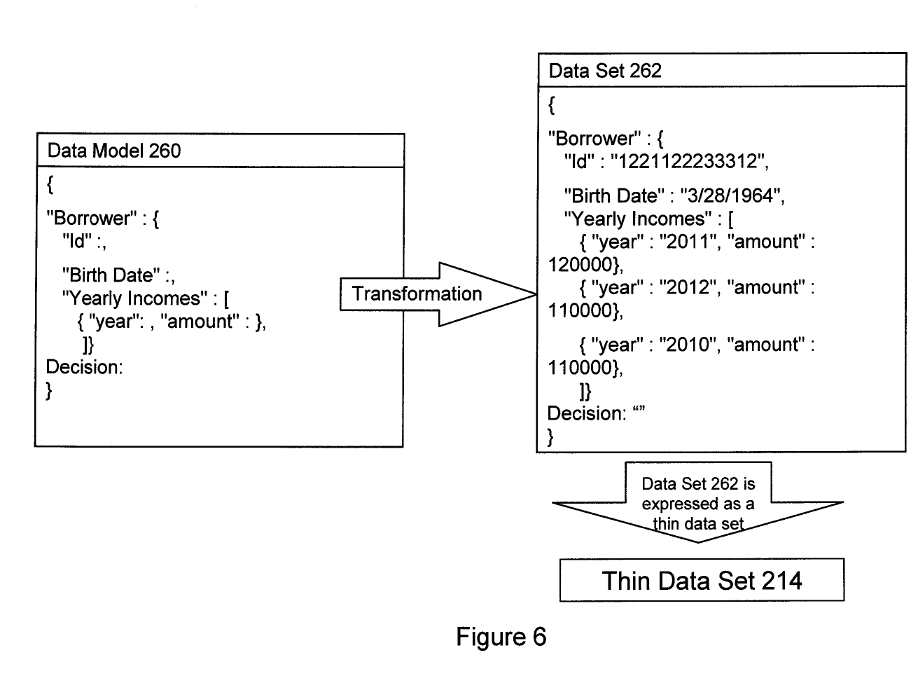

Referring now to FIG. 6, there is shown data model 260 sent to the client and there transformed to data set 262 with real data. In the example shown, the borrower Id is: 1221122233312. The Borrower's birth date is: Mar 28, 1964. Yearly Incomes are: 2011, £120000; 2012, £110000; and 2010, £110000. The decision field is null because a decision has not been made. The data is then sent to the server as thin data set 214′.

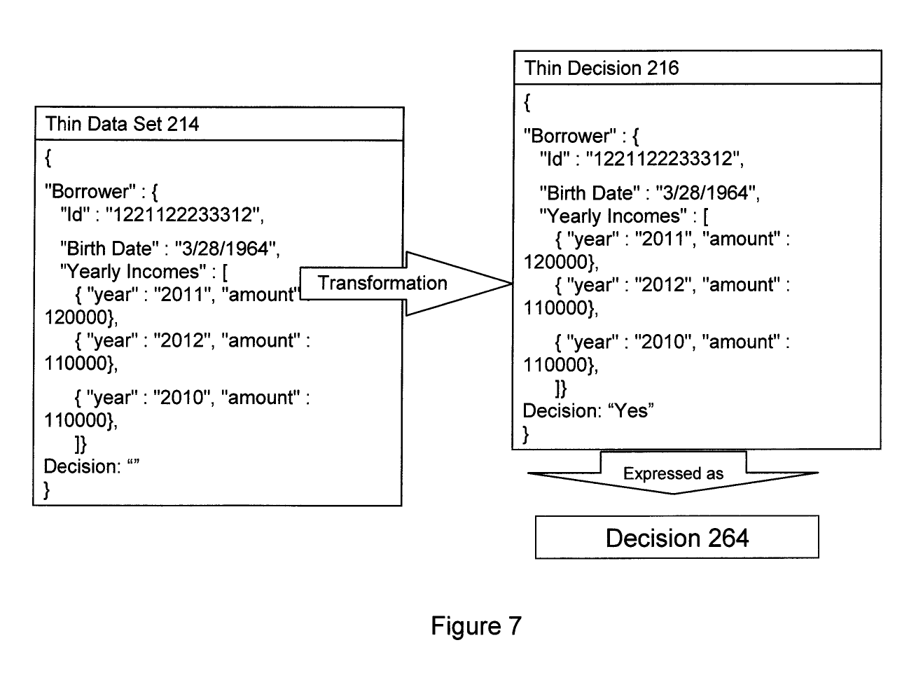

Referring to FIG. 7, there is shown thin data set 214′ transformed into thin decision 216′ by the decision service engine. The field decision in thin decision 216 is extended to contain the answer “Yes” to the rule application. The data is then sent to the client as decision 264.

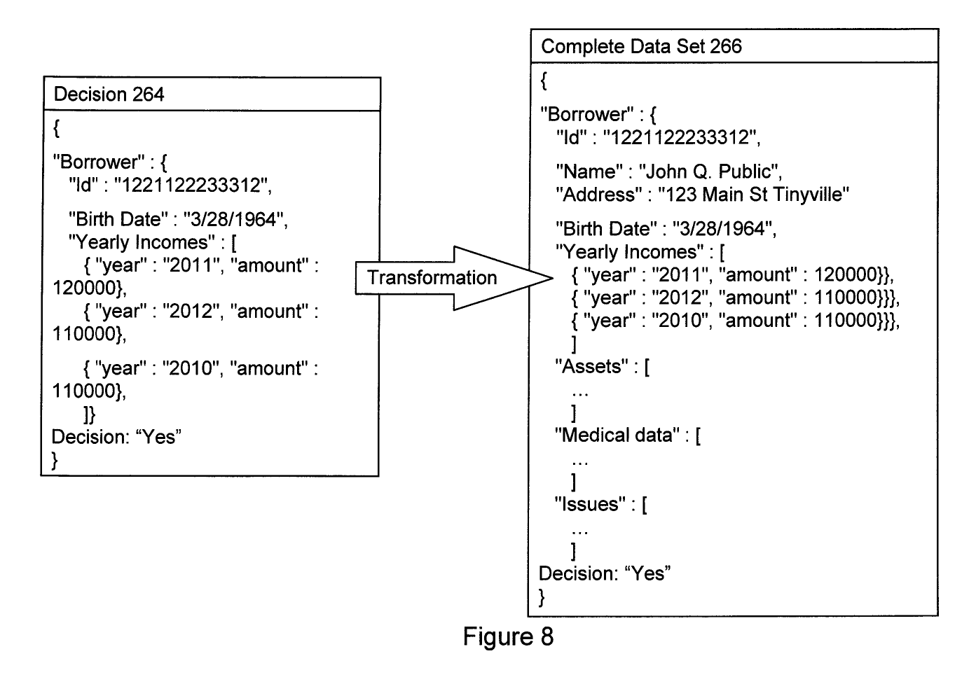

Referring to FIG. 8 there is shown decision 264 transformed into complete data set 266 by the inclusion of the extra data: “Assets”; “Medical data”; and “Issues”.

One embodiment relies on and extends an Operational Decision Management product line, and in particular a “decision server” component. This piece of software takes as input a ruleset (a dynamically assembled program as described below), composed of individual rules (execution units). The rules are composed of conditions and actions. Conditions and actions reference object model attributes. Rules are fully introspectable by the decision service, in the sense that it is possible to reconstruct an input model when given a set of rules to be used by the service.

One embodiment is implemented in the context of a business rules management system (BRMS), however, it is applicable to a wider variety of contexts. The following elements are featured in a BRMS embodiment and may appear in other embodiments:

Execution units (EU): an EU is an autonomous piece of executable code tied to a given data model that can be evaluated (conditionally or not) and performs state changes on the data model. An EU is not a function, as it does not have parameters that are to be instantiated. Rather, an EU picks its parameters from the data model (the working memory or ruleset parameters), and if they can be found, it executes itself In one embodiment, an EU is a single rule, comprising a guard, which is a set of pre-conditions that must be met for the EU to be executed. The guard also serves to instantiate parameters that are to be accessed or manipulated in the EU's body.

Execution unit properties: for the embodiments to be operable, an EU must have some identified properties that are possible to verify in an assertion. The code they describe can be queried for patterns or features, such as “is there a test that compares the age of a person to an integer value”. Embodiments can still be put to use in a more restricted context where fewer properties of an EU is available for examination and query. The embodiments involve providing means to query those properties and return a set of EU that match a given pattern.

Execution Unit Selector (selector) and Execution Set: The embodiments target programs that are dynamically assembled from a set of possible execution units, and whose properties are required to be verified. A Selector assembles a program from a set of EUs. In the embodiments, a variety of Selectors, called rule selectors, enable gathering a set of rules from a list of names, or a pattern verified by the rules to be included. The result of the execution of a Selector, the object whose properties are required to be verified dynamically, is called an execution set. While a Selector may feature various attributes, such as an execution strategy, it is only required that a selector presents a list of execution units to the algorithms used in the embodiments.

Execution Unit Interpreter: Given a set of EUs and an instance of a data model compatible with this set of rules, an Interpreter will execute all the EUs that can be executed on this instance, following a specific strategy. The strategy is a parameter of the interpreter. Most common strategies are evaluation and sequential modes, even though certain embodiments are not focused on the particular strategy used by the interpreter, provided it is deterministic. The strategy should also be complete, in the sense that all EUs in the set of rules are taken into account by the strategy.

Execution trace (trace): When a dynamically assembled program is executed, a tracer (often found in a debugging environment) can be used to trigger actions when certain instructions are performed. In one embodiment, the sequence of execution units' executions provides the data state before and after their executions. An Execution trace is an object that captures this information, as a simple sequential list of successive execution unit invocations.

In a first aspect of the invention there is provided a distributed decision method in a server comprising: receiving a call from a client requesting a decision service; sending a thin data model for that decision service to the client; receiving a thin data set from the client; forming a decision by performing the decision service on the thin data set; and sending the decision to the client.

The embodiments optimize bandwidth usage by reducing the number of superfluous exchanges that are performed. The embodiments reduce bandwidth usage but not at the expense of round trips thereby improving on the lag to make a decision.

A decision service is augmented with a new entry point that describes a thin model needed to make decisions. A thin model can be referred to as a restricted model or reduced model. A thin model is statically computed (by transitive closure computation) at compile time from an introspection of the decision logic and the data model attributes it requires. On the client side, the client uses the added entry point to send only the required portion of the data model. The server then uses a proxy representation to make the decision and return its result.

Clients take advantage of the additional entry point and benefit from optimal bandwidth and latency. Compatibility with talkative clients is preserved as the clients transmit without restriction and the decision service works as usual.

Advantageously the thin data model is built using a rule set associated with the requested decision service. A set of rules or decision procedures to perform is statically analyzed to compute a thin part of the data model that is required thereby allowing the decision service clients to transmit only the needed portions of the model.

More advantageously, the decision comprises a modified or extended data set that is returned to the client. In one embodiment, business rules are executed against the thin input dataset and the decision is a modification or extension of the thin data model and the complete thin decision returned to the caller/client.

Suitably the step of building a thin data model is performed in real time. Alternatively, the step of building a thin data model for a decision service is performed before any request for a decision service. This is advantageous when the rulesets are large and need plenty of process resource.

In one embodiment, a distributed decision method in a client comprises: calling a decision service; receiving a thin data model for that decision service; creating a thin data set by applying data to the thin data model; calling the decision service with the thin data set; and receiving a decision in return.

In one embodiment, a returned decision comprises a modified or extended thin data set.

In one embodiment, the method further comprises updating a complete data set with the thin data set and decision.

In one embodiment, the distribution decision service is part of middleware enterprise architecture including one or more of: databases; software-as-a-service architectures; Web services; Web mashups; and business process management.

One embodiment of the present invention is a system and/or computer program product that executes/enables the methods described and claimed herein.

It will be clear to one of ordinary skill in the art that all or part of the method of the embodiments may suitably and usefully be embodied in additional logic apparatus or additional logic apparatuses, comprising logic elements arranged to perform the steps of the method and that such logic elements may comprise additional hardware components, firmware components or a combination thereof.

It will be equally clear to one of skill in the art that some or all of the functional components of one embodiment may suitably be embodied in alternative logic apparatus or apparatuses comprising logic elements to perform equivalent functionality using equivalent method steps, and that such logic elements may comprise components such as logic gates in, for example a programmable logic array or application-specific integrated circuit. Such logic elements may further be embodied in enabling elements for temporarily or permanently establishing logic structures in such an array or circuit using, for example, a virtual hardware descriptor language, which may be stored and transmitted using fixed or transmittable carrier media.

It will be appreciated that the additional logic apparatus and alternative logic apparatus described above may also suitably be carried out fully or partially in software running on one or more processors, and that the software may be provided in the form of one or more computer program elements carried on any suitable data-carrier such as a magnetic or optical disk or the like.

The embodiments may suitably be embodied as a computer program product for use with a computer system. Such a computer program product may comprise a series of computer-readable instructions fixed on a non-transitory tangible medium, such as a computer readable medium, for example, diskette, CD-ROM, ROM, or hard disk. The series of computer readable instructions embodies all or part of the functionality previously described herein and such computer readable instructions can be written in a number of programming languages for use with many computer architectures or operating systems. Further, such instructions may be stored using any non-transitory memory technology, including but not limited to, semiconductor, magnetic, or optical. It is contemplated that such a computer program product may be distributed as a removable medium with accompanying printed or electronic documentation, for example, shrink-wrapped software, pre-loaded with a computer system, for example, on a system ROM or fixed disk.

In an alternative, one embodiment of the present invention may be realized in the form of a computer implemented method of deploying a service comprising steps of deploying computer program code operable to, when deployed into a computer infrastructure and executed thereon, cause the computer system to perform all the steps of the method.

It will be clear to one skilled in the art that many improvements and modifications can be made to the foregoing exemplary embodiment without departing from the scope of the present invention.

1. A distributed decision method in a server comprising:
receiving a call from a client requesting a decision service;
sending, by one or more processors, a thin data model to the client for the requested decision service, wherein the thin data model is tailored to the requested decision service;
receiving, by one or more processors, a corresponding thin data set from the client;
forming, by one or more processors, a decision by performing the requested decision service on the thin data set; and
sending, by one or more processors, the decision to the client.

2. The distributed decision method according to claim 1, wherein the thin data model is built by reducing a full data model using a rule set corresponding to the requested decision service.

3. The distributed decision method according to claim 1, wherein the decision comprises a modified data set that is returned to the client.

4. The distributed decision method according to claim 1, wherein the requested decision service is part of a middleware enterprise architecture that includes one or more of: databases; software-as-a-service architectures; Web services; Web mashups; and business process management.

5. The distributed decision method according to claim 1, further comprising:
building, by one or more processors, the thin data model of the data required for the requested decision service in real time after the call from the client.

6. The distributed decision method according to claim 1, further comprising:
building, by one or more processors, the thin data model of the data required before any request for service.

7. The distributed decision method according to claim 1, wherein the thin data model is implemented within a business rules management system (BRMS), wherein the BRMS comprises a plurality of Execution Units (EUs), wherein each EU is an autonomous piece of executable code tied to a given data model, wherein the given data model is conditionally evaluated to perform state changes on the thin data model, wherein each EU is not a function and does not have parameters that are to be instantiated, wherein each EU picks its parameters from the thin data model based on ruleset parameters, wherein each EU is a single rule that comprises a guard, wherein the guard is a set of pre-conditions that must be met for said each EU to be executed, and wherein the guard instantiates parameters that are to be accessed in each EU's body.

8. A distributed decision method in a client comprising:
calling a decision service;
receiving, by one or more processors, a thin data model for the requested decision service;
creating, by one or more processors, a thin data set by applying data to the thin data model;
calling, by one or more processors, the requested decision service with the thin data set; and
receiving, by one or more processors, a decision in return.

9. The distributed decision method according to claim 8, wherein a returned decision comprises an extended thin data set.

10. The distributed decision method according to claim 8, further comprising updating a full data set with the thin data set and the decision.

11. The distributed decision method according to claim 8, wherein the requested decision service is part of a middleware enterprise architecture that includes one or more of: databases; software-as-a-service architectures; Web services; Web mashups; and business process management.

12. The distributed decision method according to claim 8, wherein the thin data model is implemented within a business rules management system (BRMS), wherein the BRMS comprises a plurality of Execution Units (EUs), wherein each EU is an autonomous piece of executable code tied to a given data model, wherein the given data model is conditionally evaluated to perform state changes on the thin data model, wherein each EU is not a function and does not have parameters that are to be instantiated, wherein each EU picks its parameters from the thin data model based on ruleset parameters, wherein each EU is a single rule that comprises a guard, wherein the guard is a set of pre-conditions that must be met for said each EU to be executed, and wherein the guard instantiates parameters that are to be accessed in each EU's body.

13. A computer program product for creating a distributed decision service, the computer program product comprising:
one or more computer-readable storage devices and program instructions stored on at least one of the one or more computer-readable storage devices, the program instructions comprising:
program instructions to receive a call from a client requesting a decision service;
program instructions to send a thin data model to the client for the requested decision service;
program instructions to receive a corresponding thin data set from the client;
program instructions to form a decision by performing the requested decision service on the thin data set; and
program instructions to send the decision to the client.

14. The computer program product of claim 13, wherein the thin data model is built by reducing a full data model using a rule set corresponding to the requested decision service.

15. The computer program product of claim 13, wherein the decision comprises a modified data set that is returned to the client.

16. The computer program product of claim 13, wherein the requested decision service is part of a middleware enterprise architecture that includes one or more of: databases; software-as-a-service architectures; Web services; Web mashups; and business process management.

17. The computer program product of claim 13, further comprising program instructions stored on at least one of the one or more storage devices, to:
build the thin data model of the data required for the requested decision service in real time after the call from the client.

18. The computer program product of claim 13, further comprising program instructions stored on at least one of the one or more storage devices, to:
build the thin data model of the data required before any request for service.

19. The computer program product of claim 13, wherein the thin data model is implemented within a business rules management system (BRMS), wherein the BRMS comprises a plurality of Execution Units (EUs), wherein each EU is an autonomous piece of executable code tied to a given data model, wherein the given data model is conditionally evaluated to perform state changes on the thin data model, wherein each EU is not a function and does not have parameters that are to be instantiated, wherein each EU picks its parameters from the thin data model based on ruleset parameters, wherein each EU is a single rule that comprises a guard, wherein the guard is a set of pre-conditions that must be met for said each EU to be executed, and wherein the guard instantiates parameters that are to be accessed in each EU's body.
